(19) United States
(12) Patent Application Publication
(10) Pub. No.: US 2007/0298961 A1
(43) Pub. Date: Dec. 27, 2007

(54) METHOD OF PRODUCING ELECTRODES

(76) Inventors: Gordon L. Rice, Albuquerque, NM (US); Paolina Atanassova, Albuquerque, NM (US); James H. Brewster, Rio Rancho, NM (US); David Dericotte, Albuquerque, NM (US); Bryan G. Apodaca, Albuquerque, NM (US); Toivo T. Kodas, Albuquerque, NM (US); Mark J. Hampden-Smith, Albuquerque, NM (US)

Correspondence Address: ROBERTS, MLOTKOWSKI & HOBBES, P. O. BOX 10064, MCLEAN, VA, 22102-8064, US

(21) Appl. No.: 11/425,767

(22) Filed: Jun. 22, 2006

(51) Int. Cl. H01M 4/88

(52) U.S. Cl. 502/101

(57) ABSTRACT

In a method of producing an electrode comprising a layer of an electrocatalytic material on a substrate, at least one liquid medium containing a precursor to the electrocatalytic material is atomized to produce droplets containing the precursor and the droplets are entrained in a stream of carrier gas moving in a first direction. The droplets entrained in the carrier gas stream are then heated to remove the liquid medium and convert the precursor to particles of the electrocatalytic material. The electrocatalytic material particles entrained in said carrier gas stream are then brought into contact with the substrate, whereby the electrocatalytic particles are separated from the carrier gas and collected on the substrate. By imparting relative movement between the substrate and the carrier gas stream in a second direction substantially perpendicular to the first direction a continuous layer of the electrocatalytic material can be progressively deposited on the substrate.

### STATEMENT REGARDING FEDERALLY SPONSORED RESEARCH OR DEVELOPMENT

This invention was developed under National Institute of Standards (NIST) Advanced Technology Program (ATP) Cooperative Agreement #70NANB2H3020.

### FIELD

This invention relates to a method of producing electrodes and particularly, but not exclusively, electrodes for use in fuel cells.

### BACKGROUND

Fuel cells are electrochemical devices in which the energy from a chemical reaction is converted to direct current electricity. During operation of a fuel cell, a continuous flow of fuel, e.g., hydrogen (or a liquid fuel such as methanol), is fed to the anode while, simultaneously a continuous flow of an oxidant, e.g., air, is fed to the cathode. The fuel is oxidized at the anode causing a release of electrons through the agency of a catalyst. These electrons are then conducted through an external load to the cathode, where the oxidant is reduced and the electrons are consumed, again through the agency of a catalyst. The constant flow of electrons from the anode to the cathode constitutes an electrical current which can be made to do useful work.

The Polymer Electrolyte Membrane Fuel Cell (PEMFC) is the most likely type of fuel cell to find wide application as a more efficient and lower emission power generation technology in a range of markets including stationary and portable power devices and as an alternative to the internal combustion engine in transportation. PEM fuel cells use a solid polymer as an electrolyte and porous carbon electrodes containing a platinum catalyst. They need only hydrogen oxygen from the air, and water to operate and do not require corrosive fluids like some fuel cells. They are typically fueled with pure hydrogen supplied from storage tanks or onboard reformers.

The Direct Methanol Fuel Cell (DMFC) is similar to the PEMFC in that the electrolyte is a polymer and the charge carrier is the hydrogen ion (proton). However, the liquid methanol (CH₃OH) is oxidized in the presence of water at the anode generating CO₂, hydrogen ions and the electrons that travel through the external circuit as the electric output of the fuel cell. The hydrogen ions travel through the electrolyte and react with oxygen from the air and the electrons from the external circuit to form water at the anode completing the circuit.

In the PEMFC the combined laminate structure formed from the membrane and the two electrodes is known as a membrane electrode assembly (MEA). The MEA will typically comprise several layers, but can in general be considered, at its basic level, to have five layers, which are defined principally by their function. On either side of the membrane an anode and cathode electrocatalyst is incorporated to increase the rates of the desired electrode reactions. In contact with the electrocatalyst containing layers, on the opposite face to that in contact with the membrane, are the anode and cathode gas diffusion substrate layers.

The anode gas diffusion substrate is designed to be porous and to allow the reactant hydrogen or methanol to enter from the face of the substrate exposed to the reactant fuel supply, and then to diffuse through the thickness of the substrate to the layer which contains the electrocatalyst, usually platinum metal based, to maximize the electrochemical oxidation of hydrogen or methanol. The anode electrocatalyst layer is also designed to comprise some level of the proton-conducting electrolyte in contact with the same electrocatalyst reaction sites. With acidic electrolyte types protons are produced as the product of the reaction occurring at the anode and these can then be efficiently transported from the anode reaction sites through the electrolyte to the cathode layers.

The cathode gas diffusion substrate is also designed to be porous and to allow oxygen or air to enter the substrate and diffuse through to the electrocatalyst layer reaction sites. The cathode electrocatalyst combines the protons with oxygen and electrons to produce water and is also designed to comprise some level of the proton-conducting electrolyte in contact with the same electrocatalyst reaction sites. Product water then has to diffuse out of the cathode structure. The structure of the cathode has to be designed such that it enables the efficient removal of the product water.

The complete MEA can be constructed by several methods. The electrocatalyst layers can be bonded to one surface of the gas diffusion substrates to form what is known as a gas diffusion electrode. The MEA is then formed by combining two gas diffusion electrodes with the solid proton-conducting membrane. Alternatively, the MEA may be formed from two porous gas diffusion substrates between which is sandwiched a solid proton-conducting polymer membrane having electrocatalyst layers on both sides (also referred to as a catalyst coated membrane or CCM); or indeed the MEA may be formed from one gas diffusion electrode, one gas diffusion substrate and a solid proton-conducting polymer having an electrocatalyst layer on the side facing the gas diffusion substrate.

Although the theory behind fuel cell operation has been known for many years, there has been difficulty producing commercially viable fuel cells due to technological barriers, and also due to the availability of more cost-effective energy sources such as petroleum. However, devices using petroleum products, such as the automobile, produce significant pollution and may eventually become obsolete with the depletion of petroleum resources. As a result, there is a need for an alternative means for producing energy. Fuel cells are a promising alternative source of energy in that they are relatively pollution-free and utilize hydrogen, a seemingly infinite fuel source.

Among the critical issues that must be addressed for the successful commercialization of fuel cells are cell cost, cell performance and operating lifetime. For stationary applications, improved power density is also critical. For automotive applications, high voltage efficiencies are necessary. In terms of cell cost, one of the major issues is the construction and fabrication of the electrodes, not least because of the fact that most fuel cells currently employ expensive noble metals, particularly platinum, as the or one electrocatalyst material. In particular, there is a need for improved methods for continuously and rapidly producing fuel cell electrodes in which the deposition of the electrocatalyst layer can be closely controlled.

Many different methods have been proposed for producing fuel cell electrodes, but most suffer from drawbacks that limit or prevent their commercial application. For example, U.S. Pat. No. 4,052,336 discloses a process for preparing an active noble metal catalyst on a carbon carrier, such as palladium on carbon, by impregnating a solution of a metal salt onto the carbon, forming an oxide or hydroxide from the metal salt and reducing the oxide or hydroxide to a metal. However, this process generally results in poor control over the composition and microstructure of the catalyst powder, which are characteristics that have a critical impact on the performance of the catalyst.

It is also known to produce fuel cell electrodes by depositing platinum onto porous carbon materials using plasma sputtering techniques, “Plasma sputtering deposition of platinum into porous fuel cell electrodes”, P Brault et al. 2004 J. Phys. D: Appl. Phys. 37, 3419-3423.

A method for the production of composite electrocatalyst particles having well-controlled microstructure and morphology is disclosed in U.S. Patent Application Publication No. 2003/0130114 and comprises the steps of a) forming a liquid precursor comprising a particulate carbon precursor and at least a first precursor to an active species phase; b) generating an aerosol of droplets from said liquid precursor; and c) heating the aerosol droplets in a spray dryer at a conversion temperature of not greater than about 400° C. to form electrocatalyst particles wherein said first precursor is converted to an active species phase dispersed on the carbon support phase. The electrocatalyst particles are collected by filtration or with cyclones and can then be deposited onto an electrode support by a number of different deposition methods. Suitable deposition methods are said to include the direct deposition of the dry powder such as by dusting, electrophotography or electrostatic precipitation. Other deposition methods involve liquid vehicles such as ink jet printing, toner deposition, slurry deposition, paste-based methods and electrophoresis.

According to the present invention, a simplified method of producing electrodes has now been developed in which a stream of electrocatalyst particles is produced by heating aerosol droplets containing a precursor to the electrocatalyst species and then collecting the resultant electrocatalyst particles as a continuous catalyst layer directly on the substrate of the electrode. In this way, the present method combines the particle collection and deposition steps with the particle formation step to provide a single stage process for producing an electrocatalyst layer having well-controlled microstructure and morphology.

U.S. Patent Publication 2002/0184969 to Kodas et al. discloses a method for fabricating and analyzing particulates, including electrocatalyst materials, having a varying material property such that particulates having a selected desirable material property can be identified. The method comprises the steps of: a) continuously providing a precursor composition to a reactor; b) continuously reacting said precursor composition in said reactor under at least one reactor condition to form reacted precursor particles; and c) collecting said reacted precursor particles, wherein said precursor composition is varied on a real-time basis such that said reacted precursor particles comprise a first reacted precursor portion at a first time and a second reacted precursor portion at a second time and at least one material property of said first reacted precursor portion is different than said one material property of said second reacted precursor portion. The collecting step conveniently comprises depositing the reacted precursor particles in a substantially continuous manner on a substrate to form a linear feature having a compositional gradient.

International Patent Publication No. WO 01/79808 discloses a combinatorial synthesis method for producing a plurality of compositions having materially different characteristics using an apparatus having a plurality of collectors. The method comprises reacting a first quantity of fluid reactants to form a first quantity of product composition and, following completion of the collection of the first quantity of product composition, reacting a second quantity of fluid reactants to form a second quantity of product composition, the second quantity of product composition being materially different from the first quantity of product composition. The apparatus includes a nozzle connected to a reactant source and a plurality of collectors, each collector comprising a gas permeable membrane. The nozzle and plurality of collectors move relative to each other such that a collector can be selectively placed to receive a fluid stream emanating from the nozzle. The plurality of product compositions can be evaluated to determine their suitability for various applications.

In our co-pending U.S. patent application Ser. No. 11/136277, filed May 24, 2005, we have described a high throughput method for synthesizing different powder compositions for testing. The method comprises forming a mixture from controlled amounts of selected chemical components according to calculated control values; atomizing the mixture into droplets and entraining the droplets in a carrier gas; processing the aerosol droplets by heating and converting the droplets into a fine powder entrained in the carrier gas; cooling the carrier gas and powder; causing the carrier gas and powder to flow past a porous filter at a calculated rate to separate the powder from the carrier gas; collecting and storing the powder on a surface of the porous filter; and removing the powder from the porous filter for testing.

### SUMMARY

The present invention resides in a method of producing an electrode comprising a layer of an electrocatalytic material on a substrate, the method comprising:

(a) providing at least one liquid medium containing a precursor to said electrocatalytic material;

(b) atomizing said at least one liquid medium to produce droplets containing said precursor and entraining the droplets in a stream of carrier gas moving in a first direction;

(c) heating the droplets entrained in the carrier gas stream to remove the liquid medium and convert the precursor to particles of said electrocatalytic material;

(d) causing said particles of electrocatalytic material entrained in said carrier gas stream to contact said substrate, whereby said particles of electrocatalytic material are separated from the carrier gas and collected on said substrate; and

(e) imparting relative movement between said substrate and the carrier gas stream in a second direction substantially perpendicular to the first direction to progressively deposit a continuous layer of said electrocatalytic material on the substrate.

Conveniently, said electrocatalytic material comprises a particulate carbon support phase and an active metal species dispersed on said support phase.

In one embodiment, a single liquid medium contains carbon particles and a precursor to said active metal species.

In an alternative embodiment, a first liquid medium contains carbon particles and a second liquid medium contains a precursor to said active metal species. Conveniently, said first and second liquid media are mixed prior to the atomizing (b). Alternatively, said first and second liquid media are separately atomized in (b) to produce droplets containing said precursor and droplets containing said carbon particles.

Conveniently, said active metal species is selected from Pt, Rh, Ir, Ru, Pd, Ni, Co, Fe, Cu, Re, Mo, W, Zn, Mn and combinations and alloys thereof and preferably comprises platinum.

Typically, said heating (c) heats said droplets entrained in the carrier gas stream to a temperature of less than 900° C., preferably less than 700° C., more preferably less than 500° C.

In one embodiment, the method further includes cooling said particles of electrocatalytic material and said carrier gas stream prior to (d). Conveniently, at least one of an ionomer and a binder is added to the carrier gas stream during or after said cooling and prior to (d). Typically, the ionomer comprises a perfluorosulfonate and/or a polybenzimidazole, whereas the binder typically comprises polytetrafluoroethylene PTFE).

Typically, said substrate is moved in said second direction past said carrier gas stream. Conveniently, said substrate is in the form of elongated strip that is moved from a feed spool past said carrier gas stream to a take-up spool. Preferably, said substrate is porous and more preferably comprises a carbonaceous material.

### BRIEF DESCRIPTION OF THE DRAWINGS

FIG. 1 is a schematic illustration of a two-fluid nozzle that is useful for the production of electrocatalyst powders according to an embodiment of the present invention.

FIG. 2 is a schematic illustration of a spray dryer that is useful for the production of electrocatalyst powders according to an embodiment of the present invention.

FIG. 3 is a schematic illustration of a device for depositing electrocatalyst powder on an electrode substrate material.

### DETAILED DESCRIPTION OF THE EMBODIMENTS

The present invention is directed to a method of producing an electrode, and particularly a fuel cell electrode, wherein the electrode comprises a layer of an electrocatalytic material on a substrate, such as a proton-conducting polymer membrane or a porous gas diffusion substrate. The present method involves initially providing at least one liquid medium containing a precursor to the desired electrocatalytic material, such as platinum, and then atomizing the liquid medium to produce droplets containing the precursor. After entraining the droplets in a stream of carrier gas moving in a first direction, the droplets are heated to remove the liquid medium and convert the precursor to particles of the electrocatalytic material also entrained in the carrier gas stream. The particles of electrocatalytic material in said carrier gas stream are then caused to contact the electrode substrate, whereby the particles of electrocatalytic material are separated from the carrier gas and collected on the substrate. By imparting relative movement between the substrate and the carrier gas stream in a second direction substantially perpendicular to the first direction a continuous layer of the electrocatalytic material is progressively deposited on the substrate. Alternatively, by masking areas of the substrate, the electrocatalytic material can be selectively deposited on the unmasked areas of substrate as the substrate is moved relative to the carrier gas stream.

### Electrocatalytic Layer

The electrocatalytic layer of the electrode produced by the present method comprises particles of at least a first electrocatalytically active species, such as a metal or a metal oxide, which is either unsupported or is dispersed on a support phase, such as carbon or at least one of a metal oxide, carbide, and nitride. The particular electrochemically active species employed will depend on the intended use of the electrode but, for fuel cell use, preferred metals for the electrocatalytically active species include Pt, Rh, Ir, Ru, Pd, Ni, Co, Fe, Cu, Re, Mo, W, Zn, Mn and combinations or alloys (including binary, ternary and quaternary alloys) of these metals. Preferred metal alloys include alloys of Pt with other metals, such as Ru, Ni, Mn and Co. Particularly preferred among these is Pt/Ru for use in reformed hydrogen and Direct Methanol Fuel Cell (DMFC) anodes and Pt/Cr/Co for use in oxygen cathodes.

Another preferred embodiment of the present invention is directed to metal oxide-carbon composite electrocatalyst particles which include an active metal oxide species dispersed on a carbon support. The metal oxide active species phase can be selected from the oxides of the transition metals, preferably those existing in oxides of variable oxidation states, and most preferably from those having an oxygen deficiency in their crystalline structure. For example, the dispersed metal oxide can be an oxide of the metals Au, Ag, Pt, Pd, Ni, Co, Rh, Ru, Fe, Mn, Cr, Mo, Re, W, Ta, Nb, V, Hf, Zr, Ti or Al. A particularly preferred metal oxide according to the present invention is manganese oxide (MnOₓ, where x is 1 to 2). The dispersed active phase can include a mixture of different oxides, solid solutions of two or more different metal oxides or double oxides. The metal oxides can be stoichiometric or non-stoichiometric and can be mixtures of oxides of one metal having different oxidation states. The metal oxides can also be amorphous.

Where the electrocatalytically active species is dispersed on a particulate support, the preferred support material is carbon. Suitable carbon supports typically have high purity and a high surface area, pores predominantly in the mesoporous range, such as 30-100 nm, and a high durability at the operating conditions for the specific application. Graphitic carbon is generally preferred for long term operational stability of fuel cells and batteries.

Typically, the composite electrocatalyst particles include a carbon support with at least about 1 weight percent active species, more preferably at least about 5 weight percent active species and even more preferably at least about 10 weight percent of the catalytically active species dispersed on the support surface. In one embodiment, the particles include from about 20 to about 90 weight percent of the active species phase, with the preferred level depending upon the total surface area of the carbon, the type of active species and the application of the powder. A carbon support having a low surface area will require a lower percentage of active species on its surface to achieve a similar surface concentration of the active species compared to a support with higher surface area and higher active species loading.

It is preferred that the average size of the active species phase dispersed on the support phase is such that the particles include small single crystals or crystallite clusters, collectively referred to herein as clusters. Typically, the average active species cluster size is not greater than about 10 nanometers, more preferably is not greater than about 5 nanometers and even more preferably is not greater than about 3 nanometers. In one embodiment, the average cluster size is from about 0.5 to 5 nanometers. According to another embodiment, at least about 50 percent by number, more preferably at least about 60 percent by number and even more preferably at least about 70 percent by number of the active species clusters have a size of not greater than about 3 nanometers. Composite electrocatalyst powders having such small crystallite clusters advantageously have enhanced catalytic properties as compared to composite powders comprising an active species phase having larger clusters. The method of the present invention advantageously permits control over the crystallinity by controlling the reaction temperature and/or residence time.

The overall electrocatalyst powder (active species on the particulate support) produced by the present method has a well-controlled particle size. According to one embodiment of the present invention, the volume average particle size is not greater than about 100 μm, preferably is not greater than about 20 μm and more preferably is not greater than about 10 μm. Further, it is preferred that the volume average particle size is at least about 0.3 μm, more preferably is at least about 0.5 μm and even more preferably is at least about 1 μm. In one embodiment, the volume average particle size of the electrocatalyst powder is 5 to 7 μm. As used herein, the average particle size is the median particle size (d50). Powder batches having an average particle size within the preferred parameters disclosed herein enable the formation of thin electrocatalytic layers which are advantageous for producing energy devices such as batteries and fuel cells.

According to one embodiment of the present invention, the electrocatalyst particles are polymer-modified by coating the particles with a polymer, for example a tetrafluoroethylene (TFE) fluorocarbon polymer such as Teflon® (E.I. duPont de Nemours, Wilmington, Del.) or a proton conducting polymer such as a sulfonated perfluorohydrocarbon polymer (e.g., Nafion®, E.I. duPont de Nemours, Wilmington, Del.) or a polybenzimidazole. Polymer-modified carbon particles can be used, for example, to form hydrophobic layers in an energy device, as is discussed below. The hydrophobicity can be controlled by controlling the ratio of Teflon® to carbon.

### Electrode Substrate

The composition of the substrate of the electrode is not narrowly defined and will depend on the final use of the electrode. It is, however, preferred that the substrate material be flexible so that an elongated strip of the substrate material can be mounted on a supply roll and then progressively removed from the supply roll to receive a continuous deposit of the particulate electrocatalytic material produced according to the present method. The resultant coated substrate can then be retrieved onto a take-up spool or otherwise recovered for production of one or more electrodes.

In one embodiment, where the final electrode is intended to form part of a catalyst coated membrane, the substrate is proton conductive and electronically insulative ion exchange membrane formed from a solid, organic polymer, which preferably comprises a poly[perfluorosulfonic] acid, but which may comprise polysulfones, perfluorocarbonic acid polyvinylidene fluoride PVDF) and styrene-divinylbenzene sulfonic acid. A particularly preferred substrate material is Nafion® (du Pont de Nemours and Co., Wilmington, Del., USA), which comprises a base in the form of a copolymer of tetrafluoroethylene and perfluorovinyl ether, on which sulfonate groups are present as ion-exchange groups. An alternative substrate for use as a proton exchange membrane is polybenzimidazole (PBI), to which ion exchange groups such as phosphoric acid groups can be added.

More preferably, the substrate is porous and the final electrode is a gas or liquid diffusion electrode. Suitable porous substrates include carbon paper, carbon cloth, and metal mesh. Such substrates may optionally have a backing layer of a hydrophobic carbon material. This can comprise either a high surface area, porous, particulate conductive carbon material, for example, furnace carbon blacks, or acetylene blacks, or the carbon may be mixed with a suitable hydrophobic polymer such as polytetrafluoroethylene (PTFE), or ethylene-propylene copolymer (FEP). This can be applied to the substrate by any known method, such as spraying or screen printing, and heat treated at an appropriate temperature to provide the correct hydrophobic properties, prior to application of the active layer by the present method.

### Manufacture of the Electrode

The first step in the fabrication of an electrode is to produce a liquid medium containing at least one precursor to the electrocatalyst particles. In the case of a supported electrocatalyst powder, the liquid medium conveniently includes precursors to both the active species and the support phase. Alternatively, individual liquid media containing precursors to the active species and the support phase can be formed separately and mixed at the precursor stage or later in the process of electrode fabrication. Proper selection of the precursors enables the production of particles having well-controlled chemical and physical properties.

Where the electrocatalyst particles include a metal, the precursor solution includes at least one metal precursor. The metal precursor may be a substance in either a liquid or solid phase. Preferably, the metal precursor is a metal-containing compound, such as a salt, dissolved in a liquid solvent of the liquid feed. For example, the precursor solution can include nitrates, chlorides, sulfates, hydroxides, or carboxylates of a metal. However, chloride salts may lead to detrimental catalytic properties over time and are therefore generally not preferred. The metal precursor will undergo one or more chemical reactions when heated to convert it to a metallic state and form the desired electrocatalyst particles.

Where the electrochemically active species is an alloy of two or more metals, the precursor solution can contain a precursor to each metal and the subsequent heating step can be arranged to effect not only conversion of the precursors to the desired metals but also alloying of the metals. Alternatively, a separate alloying step can be performed after deposition of the metals onto the substrate, either in a single or in multiple deposition steps.

A preferred catalytically active metal according to one embodiment of the present invention is platinum (Pt). Preferred precursors for platinum metal include teraammineplatinum (II) hydroxide (Pt(NH₃)₄(OH)₂), tetraamineplatinum (II) nitrate (Pt(NH₃)₄(NO₃)₂) and hydroxoplatinic acid (H₂Pt(OH)₆). Other platinum precursors include Pt-nitrates, Pt-amine nitrates, Na₂PtCl₄, and the like. H₂Pt(OH)₆ is advantageous since it converts to platinum metal at relatively low temperatures.

According to another embodiment, palladium is employed as the catalytically active metal. Suitable palladium precursors include inorganic Pd salts such as palladium (II) chloride (PdCl₂), palladium (II) nitrate (Pd(NO₃)₂), H₂PdCl₄, or Na₂PdCl₄. Complex Pd salts such as Pd(NH₃)₄Cl₂ or Pd(NH₃)₄(OH)₂, Pd-carboxylates, and the like are also useful.

Ruthenium (Ru) is also useful as a catalytically active metal. For ruthenium, inorganic salts can be used including the nitrate (Ru(NO₃)₃) and the chloride (RuCl₃).

For the production of metal oxide-containing electrocatalyst powders, including supported and unsupported metal oxides, the metal oxide itself or a precursor to the metal oxide is included in the precursor solution. For metal oxides, including oxides of Au, Ag, Pt, Pd, Ni, Co, Rh, Ru, Fe, Mn, Cr, Mo, Re, W, Ta, Nb, V, Hf, Zr, Ti or Al, inorganic salts including nitrates, chlorides, hydroxides, halides, sulfates, phosphates, carboxylates, oxylates and carbonates can be used as precursors. Particularly preferred metal oxide precursors include K₂Cr₂O₇, chromium carboxylates and chromium oxalate for chromium oxide; KMnO₄, manganese nitrate, acetate, carboxylates, and alkoxides for manganese oxide; Na₂WO₄ for tungsten oxide; K₂MoO₄ for molybdenum oxide; cobalt amine complexes and cobalt carboxylates for cobalt oxide; nickel amine complexes and nickel carboxylates for nickel oxide; and copper amine complexes and copper carboxylates for copper oxide.

According to one preferred embodiment, the precursor to the metal or metal oxide is a cationic precursor, that is a precursor wherein the metal (e.g., Pt) is part of the cationic species of the precursor salt. For example, a preferred cationic precursor for platinum metal is tetraamineplatinum (II) hydroxide.

For the production of composite powders having a carbon support phase, the or one precursor solution also includes at least one carbon precursor. The carbon precursor can be an organic precursor such as carboxylic acid, benzoic acid, polycarboxylic acids such as terephthalic, isophthalic, trimesic and trimellitic acids, or polynuclear carboxylic acids such as napthoic acid, or polynuclear polycarboxylic acids. However, the use of a liquid organic carbon precursor typically results in amorphous carbon, which is not desirable for most electrocatalyst applications. Preferably, the carbon support precursor is a dispersion of suspended crystalline carbon particles. The carbon particles can be suspended in water with additives, such as surfactants, to stabilize the suspension.

Among the convenient sources of dispersed carbon are commercially available carbon-based lubricants which are a suspension of fine carbon particles in an aqueous medium such as dispersed carbon black. Particularly preferred are acetylene carbon blacks having high chemical purity and good electrical conductivity. Examples of such carbon suspensions that are available commercially are GRAFO 1322 (Fuchs Lubricant Co., Harvey, Ill.) which is a suspension of VULCAN XC-72 carbon black (Cabot Corp., Alpharetta, Ga.) having an average size of about 30 nanometers and a surface area of about 254 m²/g. Also preferred are BLACKPEARLS 2000 (Cabot Corp., Alpharetta, Ga.) and KETJENBLACK EC600 (Akzo Nobel, Ltd., Amersfoort, Netherlands), each of which includes carbon having a specific surface area of from about 1300 to 1500 m²/g. Another preferred class of carbon materials is activated carbons which have a degree of catalytic activity. Examples include NORIT NK (Cabot Corp., Alpharetta, Ga.) and PWA (Calgon Carbon Corp., Pittsburgh, Pa.) having an average particle size of about 20 micrometers and a surface area of about 820 m²/g.

The carbon precursor particles preferably have a BET surface area of at least about 20 m²/g, more preferably at least about 80 m²/g, even more preferably at least about 250 m²/g and most preferably at least about 1400 m²/g. The surface area of the particulate carbon precursor strongly influences the surface area of the composite electrocatalyst powder, and therefore strongly influences the electrocatalytic activity of the composite powder.

The particulate carbon should be small enough to be dispersed and suspended in the droplets generated from the liquid precursor. According to one embodiment, the particulate carbon preferably has an average size of from about 10 to about 100 nanometers, more preferably from about 20 to about 60 nanometers. However, carbon particulates having a size of up to about 25 micrometers can also be used. The carbon can be crystalline (graphitic), amorphous or a combination of different carbon types. The particles can also have a graphitic core with an amorphous surface or an amorphous core with a graphitic surface.

The surfaces of the carbon particles can be treated to modify their surface chemistry. For example, oxidized carbon surfaces can expose hydroxyl, carboxyl, aldehyde, and other functional groups that make the surface more hydrophilic, whereas reduced carbon surfaces terminate in hydrogen that promotes hydrophobicity. The ability to select the surface chemistry allows tailoring of the hydrophobicity of the surfaces, which in turn allows producing gradients in hydrophobicity within beds of deposited particles. Oxidized carbon surfaces also tend to be microetched, corresponding to higher surface areas while reduced carbon surfaces have lower surface areas. Oxidized carbon surfaces can be derivatized by reaction with various agents that allow coupling of various oxygen containing groups to the surface to further tailor the surface chemistry. This allows the addition of inorganic, organic, metal organic or organometallic compounds to the surface.

A stable precursor suspension (carbon dispersion and metal salt) is necessary to ensure a homogeneous feedstock. A precursor that is unstable will settle in the feed reservoir during the course of the processing, resulting in droplets of varying composition, and ultimately affect the catalyst powder characteristics. In this case, a preferred mode of operation is one in which the suspension of carbon particles with molecular precursors to the metal, metal oxide or other catalytically active material is stirred to keep the particles from settling.

It is preferable to mechanically dissociate larger aggregates of the carbon powders by using, for example, a blade grinder or other type of high-speed blade mill. Thus, dispersing the carbon powder in water preferably includes: 1) if not already provided in suspension, wetting of the carbon black powder by mixing a limited amount of the dry powder with a wetting agent and a soft surfactant; 2) diluting the initial heavy suspension with the remaining water and a basic surfactant diluted in the water; and 3) breaking secondary agglomerates by sonification of the liquid suspension in an ultrasonic bath.

The precursor to the metal or metal oxide active species, for example potassium permanganate, is preferably dissolved separately in water and added in an appropriate amount to a carbon suspension, prior to breaking the secondary agglomerates. Adding the metal salt in this manner facilitates breaking the larger agglomerates and the mixing results in a less viscous slurry. After sonification, the slurries are stable for several months without any apparent sedimentation or separation of the components.

Any liquid medium can be used as the carrier for the precursor to the desired electrocatalyst species, although generally the preferred liquid carrier is water or a water-containing medium. The precursor solution can also include other additives such as surfactants, wetting agents, pH adjusters or the like. It is, however, preferred to minimize the use of such additives, while maintaining good dispersion of the precursors. Thus, for example, excess surfactants, particularly high molecular weight surfactants, can remain on the electrocatalyst particle surface and degrade the catalytic activity if not fully removed.

When the electrochemically active species is a metal, the precursor solution conveniently contains one or more additives to ensure reduction of the precursor to the metal at a low temperature. Such additives will generally be soluble reducing agents and may either reduce the dissolved metal precursor before spraying or during spraying. Preferably, the reducing agent will not substantially reduce the precursor at room temperature, but will cause reduction at an elevated temperature between about 100° C. and 400° C. These reducing agents should also be water stable and any volatile species that form from the reduction should be capable of being removed from the system. Examples include boranes, borane adducts (e.g., trimethylamineborane, BH₃NMe₃), silane derivatives, e.g., SiH₍₄₋ₓ₎Rₓ (where R=an organic group, aryl, alkyl, or functionalized alkyl or aryl group, polyether, alkyl carboxylate), and borohydrides, such as, NaBH₄, NH₄BH₄, MBH₍₃₋ₓ₎Rₓ (where R=an organic group, aryl, alkyl, or functionalized alkyl or aryl group, polyether, alkyl carboxylate).

According to a particularly preferred embodiment, a reducing agent for Pt metal is selected from the group consisting of primary alcohols (e.g., methanol and ethanol), secondary alcohols (e.g. isopropanol), tertiary alcohols (e.g., t-butanol), formic acid, formaldehyde, hydrazine and hydrazine salts. For example, an acidified solution of H₂Pt(OH)₆ in the presence of formic acid is stable at room temperature but is reduced to Pt metal at low reaction temperatures, such as about 100°C.

When the electrochemically active species is a metal oxide, additives to ensure oxidation of the precursor to the metal oxide at low temperature can also be used and will generally be soluble oxidizing agents and may either oxidize the dissolved complex before spraying or during spraying. Preferably, the oxidizing agent will not oxidize the precursor to the metal oxide at room temperature, but will cause reduction at elevated temperature between about 100°C. and 400° C. These species should also be water stable and form volatile species that can be removed from the system. Examples include amine oxides, e.g., trimethylamine-N-oxide (Me₃NO), oxidizing mineral acids such as nitric acid, sulfuric acid and aqua regia, oxidizing organic acids such as carboxylic acids, phosphine oxides hydrogen peroxide, ozone or sulfur oxides.

After formation of the liquid precursor or precursors to the desired electrocatalyst powder, the or each precursor is subjected to spray conversion or spray pyrolysis, wherein the precursor is initially atomized to form a suspension of liquid precursor droplets and then the liquid is removed from the liquid precursor droplets and typically at least one component of the liquid precursor is chemically converted into a desired component of the powder.

The atomization method used to produce the precursor droplets is not narrowly defined although the manner in which the precursor droplets are generated can have significant influence over the characteristics of the final electrocatalyst powder as well as the rate of aerosol generation. Several atomization methods exist, each with advantages and disadvantages, for atomization of feed streams containing suspended particulates, like carbon, including ultrasonic transducers (usually 1-3 MHz frequency); ultrasonic nozzles (10-150 KHz); two-fluid nozzles; and pressure atomizers, as well as others known in the art. One preferred atomization method employs a two-fluid nozzle, since two-fluid nozzles have the ability to process larger volumes of liquid per time than other atomization devices, such as ultrasonic atomizers.

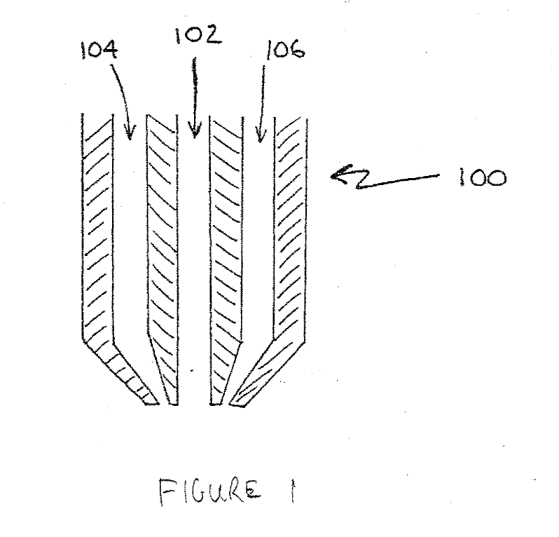

A suitable two-fluid nozzle design is illustrated in FIG. 1, in which a two fluid nozzle 100 includes a central aperture 102 for directing the liquid precursor into a chamber, while two outer apertures 104 and 106 direct jets of air or other gas toward the liquid precursor stream as the liquid precursor is sprayed out of the central aperture 102. Atomization is accomplished by the large shear forces generated when the low-velocity liquid precursor stream exiting the aperture 102 encounters the high-velocity gas jets flowing from the apertures 104 and 106. The particle size characteristics of the resultant aerosol are dependent on the flow rate of the gas jets, which in turn provide the carrier gas to transport the aerosol droplets to a heater to dry the droplets and convert the precursor to the desired to the active species.

Any conventional heater can be used to effect drying and conversion of the aerosol droplets entrained in the carrier gas stream exiting the atomizer. For example, a horizontal hot-wall tubular reactor allows controlled heating of a flowing gas stream to a desired temperature. Energy is delivered to the system by maintaining a fixed boundary temperature at the wall of the reactor and allowing heat transfer to occur through the bulk of the gas. Passive or acting mixing of the gas can be used to increase heat transfer and the heating rate of the inlet stream can be controlled using a furnace with multiple temperature zones. A more preferred heating method, especially where the atomizer is a two-fluid nozzle, is a spray drier since spray driers are generally able to handle larger flow rates than other heating mechanisms.

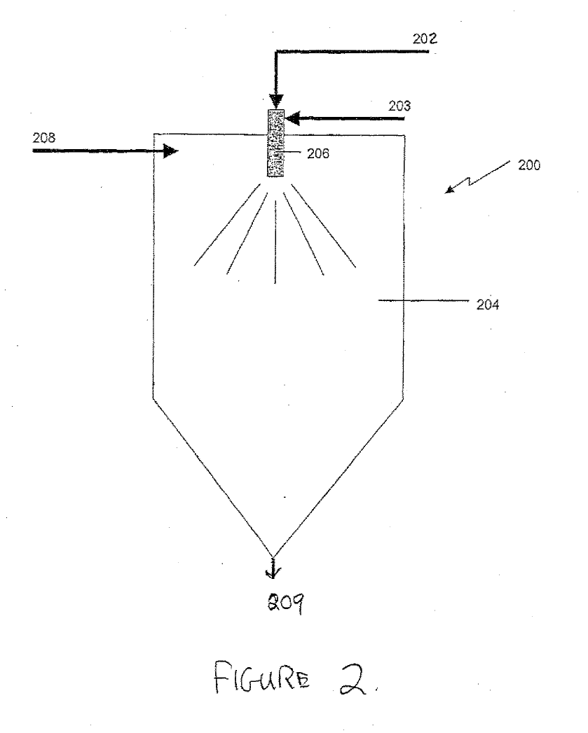

A co-current spray dryer system that is useful in the present process is schematically illustrated in FIG. 2. The spray dryer 200 includes a precursor feed line 202 for delivering liquid precursor to the drying chamber 204 and an atomizing gas line 203 for atomizing the liquid feed. The liquid precursor is dispersed into droplets through a spray nozzle 206, such as the two-fluid nozzle illustrated in FIG. 1. Heated air is introduced at the top of the chamber 204 through a gas inlet 208. The liquid droplets are dried by the heated air to form a powder, which exits the chamber entrained in the heated air through an outlet 209.

An alternative spray conversion system is based on a mixed flow spray dryer arrangement. The mixed-flow system introduces the hot gas at the top of the unit and the precursor droplets are generated near the bottom in an upward-directed fountain. This gives the particles increased residence time compared to the co-current configuration shown in FIG. 2, as the particles are forced towards the top of the unit, then fall and flow with the gas back down. The temperature the particles experience is higher as compared to a co-current spray dryer, which may be important, as some spray dryers are not capable of reaching the higher temperatures that are required for conversion of some available precursor salts.

According to the present invention, the drying of the precursors and the conversion to a catalytically active species are advantageously combined in one step, where both the removal of the solvent and the conversion of a precursor to the active species occur essentially simultaneously. Combined with a short reaction time, this enables control over the distribution of the active species on the support, the oxidation state of the active species and the crystallinity of the active species. By varying reaction time, temperature, type of support material and type of precursors, the method of the present invention can produce catalyst morphologies and active species structures which yield improved catalytic performance.

For supported electrocatalysts, it is desirable that the supported electrocatalyst particles are formed while the precursor to the active species phase is in intimate contact with the surface of the primary particles that constitute the support phase. The reaction and formation of the active species preferably occurs over a very short period of time such that the growth of large active species clusters is reduced and the migration of the active species clusters on the support surface is reduced. Preferably, the active species precursor is exposed to the elevated reaction temperature to form the active species for not more than about 600 seconds, more preferably not more than about 100 seconds and even more preferably not greater than about 10 seconds.

Generally, the temperature employed in the spray conversion step is not greater than about 900° C., such as not greater than about 700° C., for example not greater than about 500° C. Further, it is preferred that the reaction temperature is at least about 100°C., preferably at least about 150° C. Increasing the reaction temperature to over 400° C. can remove excess surfactant which may remain on the powder and poison the oxide active sites. However, this is typically not necessary if the amount of surfactant in the precursor solution, if any, is low. Higher temperatures may also be required where the spray conversion step is employed to effect alloying of two or more metals, such as to produce electrocatalyst particles comprising an alloy of Pt, Ni and Co.

After the spray conversion step, the electrocatalyst particles entrained in a carrier gas, usually the air used in the atomizer and/or the spray drier, are passed to a cooler where the particles are contacted with a quench gas, again generally air, to reduce the temperature of the particles and the carrier gas to a predetermined temperature, such as less than 150° C. Alternatives to air for the carrier and quench gases include nitrogen and forming gas (typically comprising 5% by volume hydrogen and 95% by volume nitrogen).

At or immediately following the cooling stage, other components of the final electrode are conveniently added to the mixture of electrocatalyst particles and carrier gas. Examples of such additional components are ionomers that are added to, for example, enhance the proton conductivity of the electrode. Suitable ionomers include sulfonated perfluorohydrocarbon polymers, such as Nafion®, and polybenzimidazole. Other typical additional components include hydrophobic agents to assist in water removal from the electrode, such as tetrafluoroethylene polymers, for example Teflon®, and binders to assist in adhesion of the electrocatalyst particles to the electrode substrate, such as PTFE.

After cooling, the mixture of electrocatalyst particles and carrier gas is conveniently passed through a restricted orifice, such as a narrow slit, to concentrate the flow of the mixture and is then directed to an electrode deposition device where the mixture is caused to impinge on the electrode substrate such that the particles of electrocatalytic material are separated from the carrier gas and collected on the substrate.

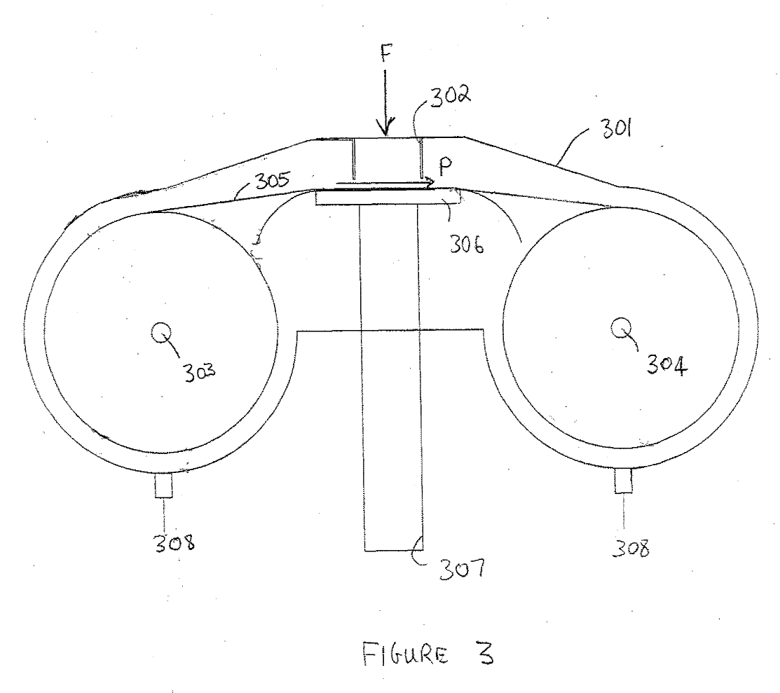

One suitable electrode deposition device is shown in FIG. 3 and includes a collection chamber 301 having an inlet orifice 302 for receiving the mixture of electrocatalyst particles and carrier gas, flowing in the direction F. Rotatably mounted within the chamber 301 on opposite sides respectively of the inlet orifice 302 are a supply spool 303 and a storage spool 304. Wound onto the supply spool 303 is an elongated strip of porous electrode substrate material 305, conveniently carbon paper, which extends from the supply spool 303 to the storage spool 304 across a grid mounted in the chamber 301 facing the inlet orifice 302. A drive mechanism (not shown) is connected to the storage spool 304 so that the spool 304 can be rotated to move the substrate material 305 over the grid 306 and past the orifice 302 in a direction P substantially perpendicular to the flow direction F. The grid 306, along with the drive assembly, keeps the substrate material 305 flat and relatively rigid to ensure that the entire volume of carrier gas/electrocatalyst mixture contacts the substrate material 66 as the mixture flows through the inlet orifice. The electrocatalyst particles entrained in the carrier gas collect on the substrate material 305 while the carrier gas flows through the grid 306 and exits the collection chamber 301 through an outlet passage 307. By controlling the rate of rotation of the storage spool 304, a constant loading of the electrocatalyst particles can be deposited on the substrate material 305 so that, after removal from the collection chamber 301, the coated strip of substrate material 305 can be divided into a plurality of individual electrodes.

If desired an additional supply spool (not shown) carrying a protective film, for example a polyimide film, such as Dupont Kapton® film, may be rotatably mounted in the chamber adjacent to the storage spool 304 and coupled to the drive assembly so that the protective film is dispensed over the electrocatalyst particles on the substrate 305 as the latter is wound onto the storage spool 304. In this way, loss of electrocatalyst powder from the substrate material 305 and transfer of the electrocatalyst powder to the rear surface of the substrate material 305 during storage on the spool 304 can be minimized.

Preferably, an inert gas, such as nitrogen, is continuously supplied to chamber 301 during powder deposition through inlets 308 located adjacent the supply spool 303 and storage spool 304. As a result, the storage spool 304 is blanketed in an oxygen free environment, which reduces the possibility of combustion of the electrocatalyst particles. In addition, by ensuring that the gap between the grid 306 and the innermost end of the inlet orifice 302 is only slightly larger than the thickness of the substrate material 305, a barrier is created by the inert gas around the inlet orifice 302 that assists in restricting the flow of electrocatalyst particles to said direction F and hence maximizes collection efficiency.

The invention will now be more particularly described with reference to the following non-limiting Examples.

### EXAMPLE 1

360 grams KB EC600 dispersion, 7 wt % carbon solids (received as Fuch Lubradol EC 1301) is diluted to 4 wt % solids with 270 g of distilled water and high shear mixed. To the aqueous carbon dispersion while still mixing, 250 g of tetraammine platinum hydroxide solution, 10 wt % platinum ((NH₃)₄Pt(OH)₂) (Heraeus Metal Processing of Santa Fe Springs Calif.) is added and the entire mixture is fiber diluted with 120 g distilled water to result in a solution with 4% solids (platinum plus carbon).

The carbon/platinum precursor solution is fed into the spray dryer through a two fluid nozzle at a rate of 1000 g solution per hour. The spray dryer is set at an inlet temperature of 575° C., outlet temperature of 300° C. along with a nozzle pressure of 60 psi.

The precursor feed is atomized and converted to electrocatalysts in the heated zone of the spray dryer. As the catalyst enters the quench a second two fluid nozzle mixes in an 10% aqueous solution of Nafion at a rate of 6 g Nafion/hour. The resulting mixture is concentrated by passing through a slit where the carrier gas and catalyst mixture are forced to pass through a layer of carbonaceous gas diffusion media such as ELAT LT-1200 (Etek).

The GDL has the dimensions of 0.1 meter by 50 meters and is moved from the feed spool to the collection spool at a rate of 0.67 meters/minute resulting in a deposition of 0.5 mg Pt/cm².

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A method of producing an electrode comprising a layer of an electrocatalytic material on a substrate, the method comprising:
(a) providing at least one liquid medium containing a precursor to said electrocatalytic material;
(b) atomizing said at least one liquid medium to produce droplets containing said precursor and entraining the droplets in a stream of carrier gas moving in a first direction;
(c) heating the droplets entrained in the carrier gas stream to remove the liquid medium and convert the precursor to particles of said electrocatalytic material;
(d) causing said particles of electrocatalytic material entrained in said carrier gas stream to contact said substrate, whereby said particles of electrocatalytic material are separated from the carrier gas and collected on said substrate; and
(e) imparting relative movement between said substrate and the carrier gas stream in a second direction substantially perpendicular to the first direction to progressively deposit a continuous layer of said electrocatalytic material on the substrate.

2. The method of claim 1, wherein said electrocatalytic material comprises a particulate carbon support phase and an active metal species dispersed on said support phase.

3. The method of claim 2, wherein a single liquid medium contains carbon particles and a precursor to said active metal species.

4. The method of claim 2, wherein a first liquid medium contains carbon particles and a second liquid medium contains a precursor to said active metal species.

5. The method of claim 4, wherein said first and second liquid media are mixed prior to the atomizing (b).

6. The method of claim 4, wherein said first and second liquid media are separately atomized in (b) to produce droplets containing said precursor and droplets containing said carbon particles.

7. The method of claim 2, wherein said active metal species is selected from Pt, Rh, Ir, Ru, Pd, Ni, Co, Fe, Cu, Re, Mo, W, Zn, Mn and combinations or alloys thereof.

8. The method of claim 2, wherein said active metal species comprises platinum.

9. The method of claim 1, wherein said heating (c) heats said droplets entrained in the carrier gas stream to a temperature of less than 900° C.

10. The method of claim 1, wherein said heating (c) heats said droplets entrained in the carrier gas stream to a temperature of less than 700° C.

11. The method of claim 1, wherein said heating (c) heats said droplets entrained in the carrier gas stream to a temperature of less than 500° C.

12. The method of claim 1 and further including cooling said particles of electrocatalytic material and said carrier gas stream prior to (d).

13. The method of claim 12, wherein at least one of an ionomer and a binder is added to the carrier gas stream during or after said cooling and prior to (d).

14. The method of claim 13, wherein the ionomer comprises a perfluorosulfonate and/or a polybenzimidazole.

15. The method of claim 13, wherein the binder comprises polytetrafluoroethylene.

16. The method of claim 1, wherein said substrate is moved in said second direction past said carrier gas stream.

17. The method of claim 2, wherein said substrate is in the form of elongated strip that is moved from a feed spool past said carrier gas stream to a take-up spool.

18. The method of claim 1, wherein said substrate is porous.

19. The method of claim 18, wherein said substrate comprises a carbonaceous material.
